(19) United States
(12) Patent Application Publication
(10) Pub. No.: US 2022/0023790 A1
(43) Pub. Date: Jan. 27, 2022

(54) NECK-MOUNTED AIR PURIFIER

(71) Applicant: AMA TECH CORP., New Taipei City (TW)

(72) Inventor: Mao-Tu Lee, New Taipei City (TW)

(21) Appl. No.: 17/107,956

(22) Filed: Dec. 1, 2020

(51) Int. Cl. B01D 46/00; B01D 46/44; B01D 46/10

(52) U.S. Cl. CPC B01D 46/0049; B01D 46/44; B01D 46/10; B01D 2279/65; B01D 46/0028; B01D 2273/30; B01D 46/0032

(57) ABSTRACT

A neck-mounted air purifier includes an air purifier host with a shell-less radial fan and an air filter mounted therein, and a collar connected to the air purifier host. The air purifier host is provided with an air intake panel and a transparent shield, and has a middle partition mounted therein to separate a fan rotation space for the mounting of the shell-less radial fan and a filter installation room for the mounting of the air filter. Two plug connection portions are provided at the air purifier host for the connection of two opposite flexible tubes of the collar, so that the transparent shield can reliably guide the filtered air to the selected blowing position.

### BACKGROUND OF THE INVENTION

### (a) Field of the Invention

The present invention relates to air purifier technology, and more particularly to a neck-mounted air purifier that can continuously provide filtered air to the user's mouth and nose to form positive pressure protection.

### (b) Description of the Prior Art

Today's portable air purifiers have pumped models, such as Taiwan patent announcement M433872 “Improved portable air filter supply device” and M395483 “Portable air filter supply device”, which drive an air pump to operate through a motor, so that the air pump presses out filtered air to the user's mouth and nose. However, the operation of the air pump makes the air delivered intermittently, so it cannot be used to form an air curtain in front of the user's nose and mouth that blocks bacteria or viruses.

In addition, in the conventional fan-type models, such as the portable air filter of Taiwan Patent M553798, the portable air filter of Taiwan Patent M552573, the portable air purifier of Taiwan Patent M375520, the portable mask that can filter air of Taiwan Patent 179985, the portable mask that can filter air of Taiwan Patent 159359, and the portable air purifier disclosed in 201114453, the source of wind power is a fan device installed in a portable chassis. The fan device includes at least a fan casing, a motor, and an axial flow fan or a radial flow fan. It is installed inside the portable air purifier. For the purifier, the fan casing and the air duct inside the purifier will not form a very airtight combination with each other. There will be a mixture of filtered clean air and unfiltered dirty air. It means that the air from the purifier cannot achieve a 100% complete filtration effect. Moreover, directly install the existing fan on the market into the portable air purifier, because the fan may not be a dedicated design, and its redundant structure (such as the fan casing) or parts, etc., will easily cause the portable air purifier to be too large and heavy.

### SUMMARY OF THE INVENTION

The present invention has been accomplished under the circumstances in view. It is the main object of the present invention to provide a neck-mounted air purifier, which, through an air purifier host and a collar, constructs an air purifier that can be used on the neck, so that the transparent shield of the air purifier host can reliably guide the filtered clean air to the user's nose and mouth, and the collar can support the air purifier host in the fitting position.

It is another object of the present invention to provide a neck-mounted air purifier, which achieves the purpose of simplifying the assembly structure and being suitable for portable neck hanging applications through the combination of an air purifier host and a collar.

To achieve these and other objects of the present invention, a neck-mounted air purifier comprises: an air purifier host, which is a hollow shell that has a closed back side, a peripheral wall and a fully hollow front side with an accommodation chamber defined therein; a middle partition set in the accommodation chamber to separate a fan rotation space and a filter installation room, the middle partition providing an air inlet opening in communication between the fan rotation space and the filter installation room; a shell-less radial fan mounted in the fan rotation space; an air filter mounted in the filter installation room; and a transparent shield set in an air outlet of the air purifier host. The air purifier host comprises two plug connection portions respectively located at two opposite sides of the front edge thereof. A collar is connected to the air purifier host, comprising a battery compartment, an electric control board mounted in the battery compartment, a battery mounted in the battery compartment and electrically connected to the electric control board, an operating interface electrically connected to the electric control board, a flexible guide tube extended from one end thereof and fixedly connected to one plug connection portion of the air purifier host for allowing the electric control board to be electrically connected with the shell-less radial fan through the flexible guide tube, and a flexible auxiliary positioning tune extended from an opposite end thereof and connected to the other plug connection portion of the air purifier host.

As a result, the neck-mounted air purifier of the present invention can construct an air purifier that can be hung on the neck through the air purifier host and the collar, so that the transparent shield of the air purifier host can reliably guide the filtered air to the mouth and nose of the user. Furthermore, through the collar to support the air purifier host to a suitable position, it can achieve the protective effect of positive pressure clean air.

Preferably, the air filter blocks and shields the air inlet opening of the middle partition, so that the air entering the fan rotation space from the air inlet opening is filtered by the air filter.

Preferably, the middle partition has a filter installation frame facing the fully hollow front side of the air purifier host, and the air filter is set in the filter installation frame, facilitating installation and replacement.

Preferably, the air filter is filter that meets the HEPA standard, which can achieve output of clean air above the safety standard.

Other and further benefits, advantages and features of the present invention will be understood by reference to the following specification in conjunction with the accompanying drawings, in which like reference characters denote like elements of structure.

### BRIEF DESCRIPTION OF THE DRAWINGS

FIG. 1 is an oblique front elevational view of a neck-mounted air purifier in accordance with the present invention.

FIG. 2 is an oblique rear elevational view of the neck-mounted air purifier in accordance with the present invention.

FIG. 3 is an exploded view of the neck-mounted air purifier in accordance with the present invention.

FIG. 4 is an exploded view of the air filter and air intake panel of the neck-mounted air purifier in accordance with the present invention.

FIG. 5 is similar to FIG. 2, illustrating the auxiliary positioning tube disconnected from the respective plug connection portion of the air purifier host.

FIG. 6 is an exploded view of the collar of the neck-mounted air purifier in accordance with the present invention.

### DETAILED DESCRIPTION OF THE PREFERRED EMBODIMENTS

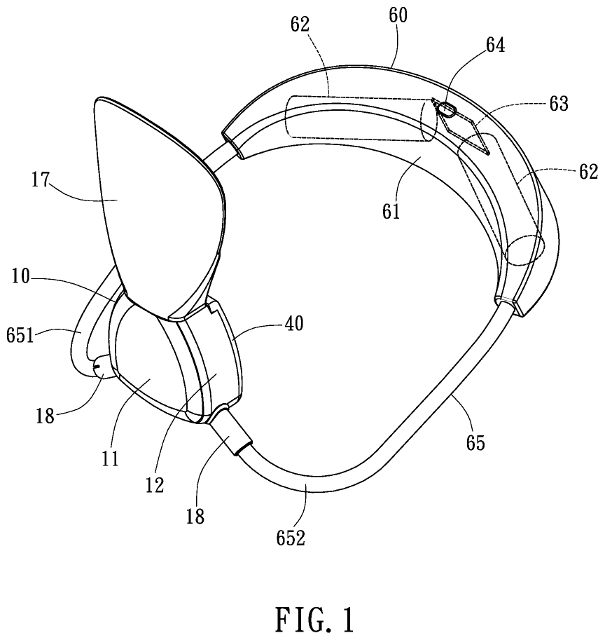

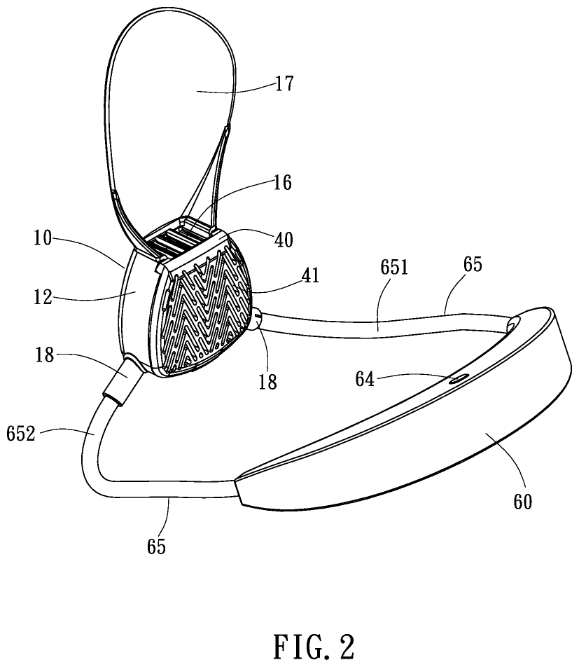

Referring to FIGS. 1-3, a neck-mounted air purifier in accordance with the present invention is to be mounted on the user's neck to continuously provide filtered air to the user's mouth and nose, or to form an air curtain in front of the user's mouth and nose when the user breathes. The neck-mounted air purifier comprises an air purifier host 10 and a collar 60.

The air purifier host 10 comprises a shell-less radial fan 20, a middle partition 30, an air intake panel 40, and an air filter 50. The structure of the air purifier host 10 is a hollow shell, preferably, but not limited to, a rectangular or circular hollow shell that has a closed back side 11, a peripheral wall 12 and a fully hollow front side 13 with an accommodation chamber 14 defined therein. The accommodation chamber 14 has a fan rotation space 15 with an opening facing the fully hollow front side 13. The fan rotation space 15 is a circular space corresponding to the fan, and it is preferably formed by a circular wall 151 protruding from the bottom of the accommodation chamber 14 toward the fully hollow front side 13. The fan rotation space 15 with its opening facing the fully hollow front side is formed in the circular wall 151, and a mounting portion 152 is provided in the center of the fan rotation space 15. An air outlet 16 is formed on the peripheral wall of the air purifier host 10, and a transparent shield 17 is attached to the outside of the air outlet 16, so that the fan in the fan rotation space 15 sends the filtered air to the air outlet 16, and the transparent shield 17 guides the air to the user's nose and mouth, or form an air curtain in front of the user's nose and mouth. Two plug connection portions 18 are respectively obliquely extended outward from two opposite lateral sides of a front edge of the air purifier host 10.

The shell-less radial fan 20 does not include any conventional fan shell or fan frame. It is a radial fan composed of a central hub 21 and a plurality of radial flow blades 22 formed around the central hub 21, and the central hub 21 is provided with a motor for driving rotation (not shown). The shell-less radial fan 20 is installed into the fan rotation space 15, and air is sucked in from the fully hollow front side opening through the shell-less radial fan 20, and then the air is sent to the aforementioned air outlet 16.

The middle partition 30 is a board, which is enclosed in the accommodation chamber 14 at the front end of the fan rotation space 15 of the air purifier host 10, leaving only an air inlet opening 31 corresponding to the air inlet part of the shell-less radial fan 20. It is better to align the edge of the air inlet opening 31 with the inner end of the radial flow blades 22 of the shell-less radial fan 20 to ensure that the radial flow blades 22 only suck in air from the air inlet opening 31.

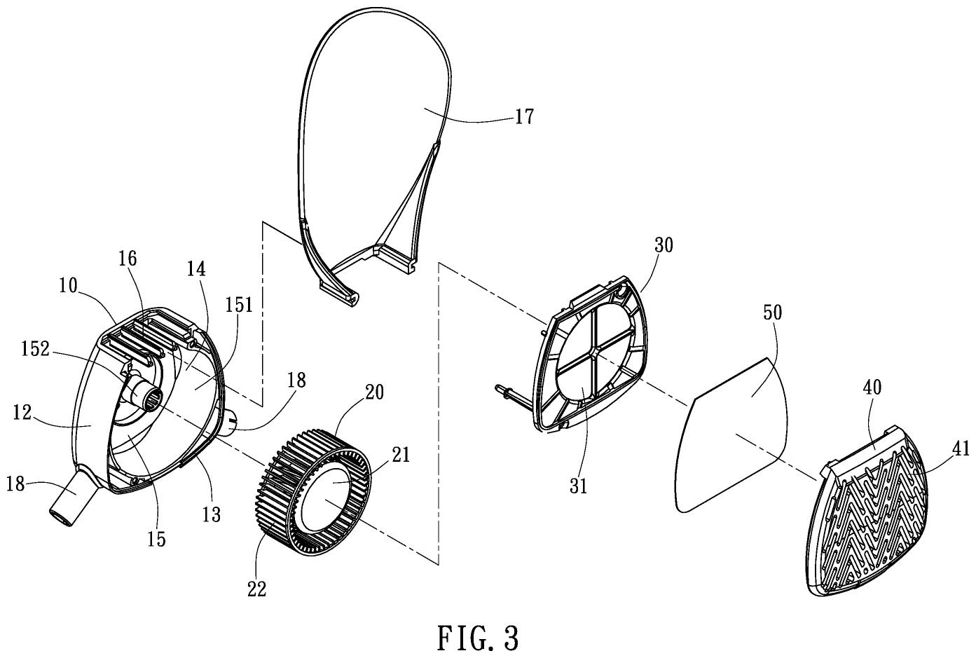

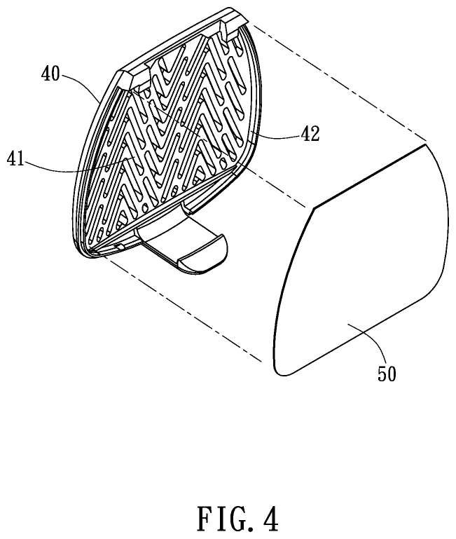

The air intake panel 40 is a plate corresponding to the entire fully hollow front side 13 of the air purifier host 10. The air intake panel 40 is provided with a plurality of intake meshes 41 through it. The air intake panel 40 has a filter installation frame 42 protruded from a front side thereof and facing the fully hollow front side 13 of the air purifier host 10 (as shown in FIG. 3 and FIG. 4). The air filter 50 is embedded in the filter installation frame 42, so that the outside air is filtered through the intake meshes 41 and then filtered through the air filter 50.

The air filter 50 is a filter that meets the HEPA standard, preferably a filter with electrostatic adsorption and sterilization effects, and its filter area corresponds to the entire accommodation chamber 14. The air filter 50 is set in the filter installation frame 42 of the air intake panel 40 (as shown in FIG. 3 and FIG. 4) to cover the air inlet opening 31. When the shell-less radial fan 20 rotates, the air filter 50 filters the inhaled air, and then the filtered air is sent through the air inlet opening 31 to the user's mouth and nose.

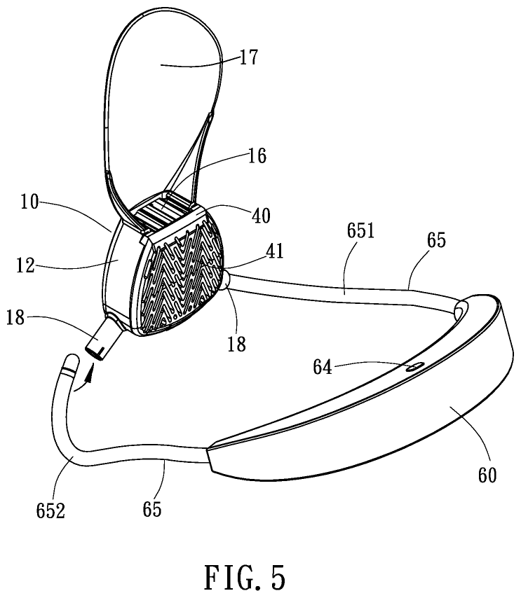

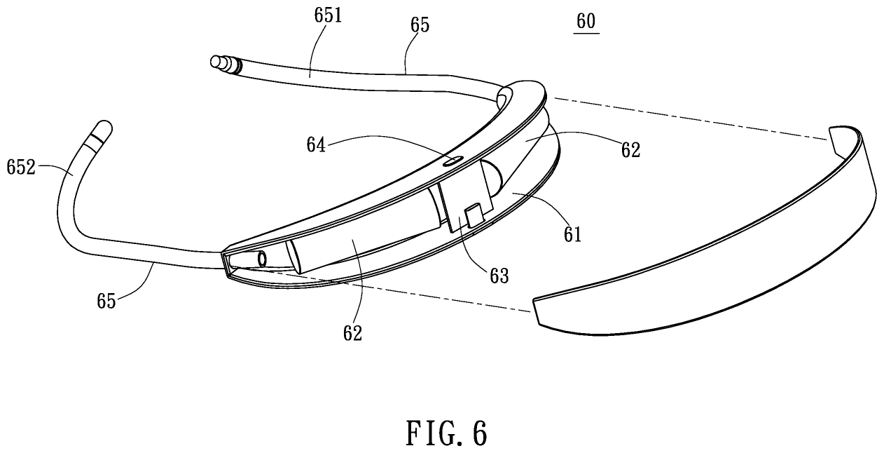

The collar 60 is formed as a semi-open shell with a curved arc shape (as shown in FIG. 5 and FIG. 6), and a battery compartment 61 is provided inside the shell. The battery compartment 61 accommodates a battery 62 and an electric control board 63 therein. The battery 62 is electrically connected to the electric control board 63. There is an operating interface 64 on one side of the collar 60 to be electrically connected to the electric control board 63. Two flexible tubes 65, namely, the guiding tube 651 and the auxiliary positioning tube 652 are respectively extended from two opposite ends of the collar 60. The end of the guide tube 651 is plugged in and fixed to one plug connection portion 18 of the air purifier host 10. The electric control board 63 can be electrically connected to the shell-less radial fan 20 through the guide tube 651. After the auxiliary positioning tube 652 and the other plug connection portion 18 of the air purifier host 10 are connected, the air purifier host 10 can obtain a better positioning effect.

In the present invention, the air purifier host 10 is mainly located through the flexible tubes 65 of the collar 60, and at the same time, the air purifier host 10 can be electrically connected and controlled by the collar 60 through the guide tube 651. Therefore, one of the preferred embodiments of the flexible tubes 65 are implemented with a flexible metal tube that is hollow and has an adjustable positioning at will. The end of the guide tube 651 is fixedly connected to the plug connection portion 18 on one side of the air purifier host 10, and the electric wire from the electric control board 63 is passed through the hollow tube body of the guide tube 651 and connected to the shell-less radial fan 20. The end of the auxiliary positioning tube 652 is plugged into the plug connection portion 18 on the other side of the air purifier host 10 in a movable plug-in manner (as shown in FIG. 5). This allows the air purifier host 10 to obtain balanced bilateral support, which helps the transparent shield 17 to guide the air to the correct position in front of the user's nose and mouth to form a protective air curtain.

When the neck-mounted air purifier of the present invention is used, through the rotation of the shell-less radial fan 20, the outside air flow passes through the air intake panel 40 and the air filter 50, adsorbing bacteria, viruses or PM2.5 on the air filter 50. The filtered air is sent to the air outlet 16 through the shell-less radial fan 20, and then the air is guided to the mouth and nose of the user through the transparent shield 17. As for other effects and purposes of the present invention, it has been as mentioned above.

The foregoing preferred embodiment is only an example of the main technology of the present invention, and not intended to limit the technical scope of the invention. Anything that involves equivalent applications or simple changes or replacements based on the preceding technical means is regarded as the technical features of the present invention.

What is claimed is:

1. A neck-mounted air purifier, comprising: an air purifier host, said air purifier host being a hollow shell that has a closed back side, a peripheral wall and a fully hollow front side with an accommodation chamber defined therein; a middle partition set in said accommodation chamber to separate a fan rotation space and a filter installation room, said middle partition providing an air inlet opening in communication between said fan rotation space and said filter installation room; a shell-less radial fan mounted in said fan rotation space; an air filter mounted in said filter installation room; and a transparent shield set in an air outlet of said air purifier host;
wherein:
said air purifier host comprises two plug connection portions respectively located at two opposite sides of a front edge thereof;
a collar is connected to said air purifier host, said collar comprising a battery compartment, an electric control board mounted in said battery compartment, a battery mounted in said battery compartment and electrically connected to said electric control board, an operating interface electrically connected to said electric control board, a flexible guide tube extended from one end thereof and fixedly connected to one said plug connection portion of said air purifier host for allowing said electric control board to be electrically connected with said shell-less radial fan through said flexible guide tube, and a flexible auxiliary positioning tune extended from an opposite end thereof and connected to the other said plug connection portion of said air purifier host.

2. The neck-mounted air purifier as claimed in claim 1, wherein said air filter blocks and shields said air inlet opening of said middle partition, so that the air entering said fan rotation space from said air inlet opening is filtered by said air filter.

3. The neck-mounted air purifier as claimed in claim 1, wherein said middle partition has a filter installation frame facing said fully hollow front side of said air purifier host; said air filter is set in said filter installation frame.

4. The neck-mounted air purifier as claimed in claim 1, wherein said air filter is filter that meets the HEPA standard.
